(19) United States
(12) Patent Application Publication
(10) Pub. No.: US 2008/0147579 A1
(43) Pub. Date: Jun. 19, 2008

(54) Discriminative training using boosted lasso

(75) Inventor: Jianfeng Gao, Kirkland, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/638,887

(22) Filed: Dec. 14, 2006

(51) Int. Cl. G06N 3/08

(52) U.S. Cl. 706/25

(57) ABSTRACT

Word sequences that contain a selected feature are identified using an index that comprises a separate entry for each of a collection of features in the language model, each entry identifying word sequences that contain the feature. The identified word sequences are used to compute a best value for a feature weight of the selected feature. A selection is made between the best value and a step-change value for the feature weight to produce a new value for the feature weight. The new value for the feature weight is then stored in a current set of feature weights for the language model.

### BACKGROUND

Language modeling is fundamental to a wide range of applications such as speech recognition and phonetic-to-character conversion. Language models provide a likelihood of a sequence of words. Traditionally, language models have been trained using a maximum likelihood approach that maximizes the likelihood of training data. Such maximum likelihood training is less than optimum because the training does not directly minimize the error rate on the training data. To address this, discriminative training methods have been proposed that directly minimize the error rate on training data. One problem with such discriminative training methods is that they can produce overly-complex models that perform poorly on unseen data.

To prevent discriminative training from forming overly-complex models, a training method known as “lasso” has been introduced. “Lasso” is a regularization method for parameter estimation in linear models. It optimizes the model parameters with respect to a lasso function that is subject to model complexities. Specifically, model parameters λ are chosen so as to minimize a regularized loss function on training data, called a Lasso Loss, which is defined as:

LassoLoss(λ,α)=ExpLoss(λ)+αT(λ) EQ. 1

where ExpLoss(λ) is an exponential loss function and αT(λ) is a penalty that increases the Lasso loss as the number or size of the model parameters increase such that T(λ)=Σ_{d=0}^{D}51 λ_{d}|. The parameter α controls the amount of regularization applied to the estimate.

Directly minimizing the lasso function of EQ. 1 with respect to λ is not possible when a very large number of model parameters are employed. In particular, it is not possible to directly minimize the lasso function when working with language model parameters,. To address this, an approximation to the lasso method known as boosted lasso or BLasso has been extended and adopted in the art.

Under BLasso, the parameters are set by performing a set of iterations. At each iteration, a single model parameter is selected and its magnitude is either increased by a fixed step or decreased by a fixed step. An increase in the magnitude of the parameter is known as a forward step. Such forward steps are taken by identifying the model parameter that will produce the smallest ExpLoss after taking the forward step. The backward step is performed by identifying the model parameter that will produce the smallest ExpLoss for a backward step change in the model parameter. However, this backward step will only be taken if it also results in a reduction in the Lasso Loss that is greater than some tolerance parameter.

The prior boosted lasso algorithm is difficult to implement in an actual language model training system because of inefficiencies in the algorithm.

The discussion above is merely provided for general background information and is not intended to be used as an aid in determining the scope of the claimed subject matter.

### SUMMARY

Word sequences that contain a selected feature are identified using an index that comprises a separate entry for each of a collection of features in the language model, each entry identifying word sequences that contain the feature. The identified word sequences are used to compute a best value for a feature weight of the selected feature. A selection is made between the best value and a step-change value for the feature weight to produce a new value for the feature weight. The new value for the feature weight is then stored in a current set of feature weights for the language model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 provides a flow diagram for training weights for a language model using boosted lasso.

FIG. 2 provides a block diagram of elements used to train weights.

FIG. 3 provides a flow diagram for choosing a value for a base feature weight.

FIG. 4 is a flow diagram for altering the weights for a language model during training.

FIG. 5 is a flow diagram of a method for computing a best weight for a selected feature.

FIG. 6 is a block diagram of a general computing environment.

### DETAILED DESCRIPTION

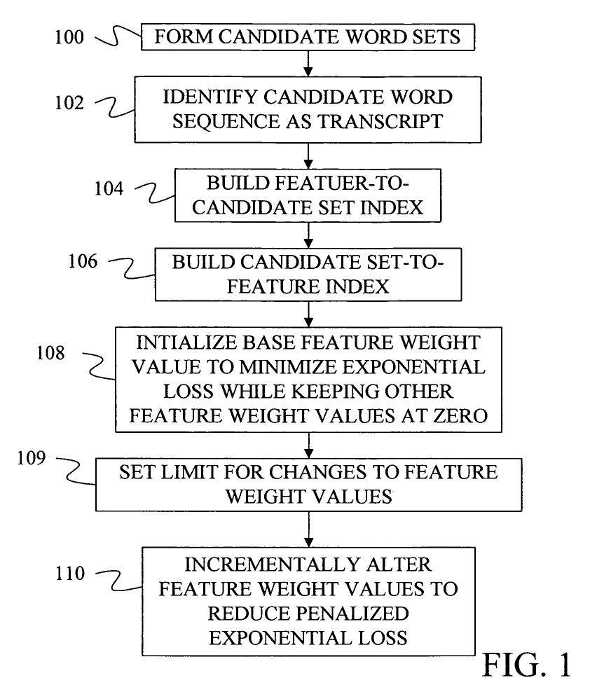

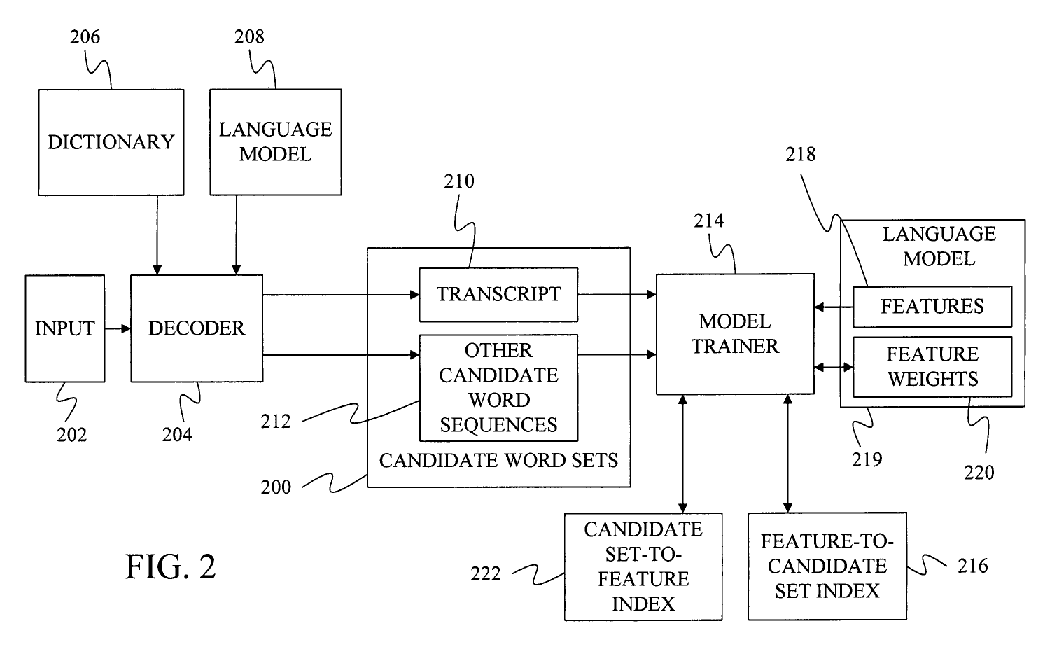

FIG. 1 provides a flow diagram of a method for training model parameters under one embodiment. FIG. 2 provides a block diagram of elements used in the method of FIG. 1.

In step 100 of FIG. 1, candidate word sets 200 are identified from inputs 202 by a decoder 204. Under some embodiments, inputs 202 are speech signals and decoder 204 is a speech recognition engine. In other embodiments, inputs 202 are phonetic sequences and decoder 204 is a phonetic-to-word conversion unit. Decoder 204 converts each input into a candidate word set 200 that contains a plurality of word sequences that can be represented by the input. For each word sequence, decoder 204 identifies a score that indicates the likelihood that the word sequence represents the input. The word sequences are identified using a dictionary 206 and a language model 208. Dictionary 206 maps phonetic or speech units to individual words or phrases. In some embodiments, dictionary 206 also provides a score that indicates the likelihood that the phonetic or speech units map to a particular word or phrase. Language model 208 provides likelihoods for sequences of words. Language model 208 is separate from the language model that is trained through the process of FIG. 1. Under one embodiment, language model 208 is a maximum likelihood language model.

At step 102, decoder 204 uses the scores for the word sequences in the candidate word sets 200 to identify a transcript 210 for each candidate word set. In particular, the highest scoring candidate word sequence in a candidate word set is identified as transcript 210, which is then treated as the proper decoding of input 202. The other candidate word sequences identified by decoder 204 are stored as other candidate word sequences 212 in candidate word set 200.

Candidate word sets 200 are provided to a model trainer 214, which uses candidate word sets 200 to train model parameters 220 of a language model 219. Under one embodiment, the model parameters are feature weights λ={λ₀, λ₁, . . . , λ_{D}} that are associated with a set of features 218 in language model 219. The features and feature weights are used by language model 219 to provide a language model score for a sequence of words W that is defined as:

$$Score ( W , λ ) = {\sum }_{d = 0}^{D} {λ}_{d} {f}_{d} ( W ) \qquad EQ . 2$$

where W is the string of words, λ_{d} is a weight for the d^{th} feature and f_{d}(W) is the value of the d^{th} feature for W.

Under one embodiment, the features include a base feature that is a log probability assigned to word sequence W by a tri-gram language model and a set of other features that include counts of word n-grams where n=1 and 2. In one embodiment, 860,000 features are used.

Model trainer 214 uses candidate word sets 200 to identify values for the feature weights 220 using a discriminative training technique discussed further below. Before training the feature weights 220, model trainer 214 builds a feature-to-candidate set index 216 based on candidate word sets 200 at step 104. Feature-to-candidate word set index 216 provides an entry for each feature in features 218. Each entry includes a listing of the candidate word sets 200 in which the feature appears in either transcript 210 or one of the other candidate word sequences 212. Thus, using feature-to-candidate set index 216, it is possible to identify all of the candidate word sets that include a feature. In other embodiments, feature-to-candidate set index 216 provides a listing of individual candidate words sequences 212 or transcripts 210 that contain the feature.

At step 106, model trainer 214 builds a candidate set-to-feature index 222. Candidate set-to-feature index 222 includes an entry for each candidate set. Each entry lists features that are found within the entry's candidate word set. Thus, using candidate set-to-feature index 222, model trainer 214 can identify all features that are found in either transcripts 210 or other candidate word sequences 212 of candidate word set 200.

At step 108, model trainer 214 initializes a base feature weight λ₀ of feature weights 220 to minimize an exponential loss function while keeping the other feature weights set to zero. As noted above, under one embodiment, the base feature f₀(W)associated with base feature weight λ₀ is the log probability of a word sequence as provided by a tri-gram language model.

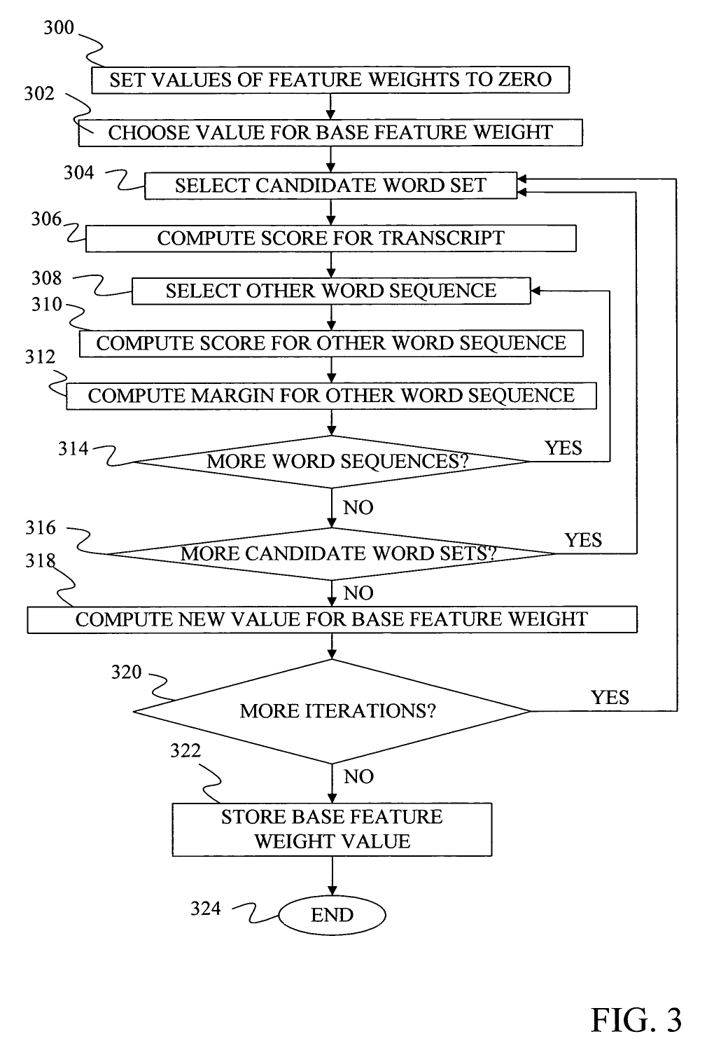

FIG. 3 provides a flow diagram of step 108. In step 300, all of the feature weights other than the base feature weight are set to zero. At step 302, a possible value for the base feature weight is selected. Under one embodiment, an initial value for the base feature weight is selected by setting a range of possible values for the base feature weight and selecting a value within that range.

At step 304, a candidate word set from candidate word sets 200 is selected. At step 306, a score for the transcript of the candidate word sequence is computed using EQ. 2 above. Since λ_{d}=0 for all features except the base feature, the summation of EQ. 2 reduces to λ₀f₀(W^{R}) where W^{R} is the transcript word sequence.

At step 308, one of the other word sequences 212 in candidate word set 200 is selected and at step 310, the score for the word sequence is computed using EQ. 2 above. Because λ_{d}=0 for all weights except λ₀, EQ. 2 simplifies to λ₀f₀(Wᵢ) where Wᵢ is the selected word sequence from step 308.

At step 312, a margin is computed for the selected word sequence using:

M(Wᵢ^{R},Wᵢ)=Score(Wᵢ^{R},λ)−Score(Wᵢ,λ) EQ. 3

where M(Wᵢ^{R},Wᵢ) is the margin between transcript Wᵢ^{R} and word sequence Wᵢ, Score(Wᵢ^{R},λ) is the score computed using EQ. 2 above for the transcript, and Score(Wᵢ,λ) is the score computed for the selected sequence using EQ. 2 above.

At step 314, the method determines if there are more word sequences in other word sequences 212 of the selected candidate word set. If there are more word sequences, the next word sequence is selected by returning to step 308. A score for the selected word sequence is computed at step 310 and a margin for the selected word sequence is computed at step 312. Steps 306, 308, 310, 312 and 314 are repeated for each word sequence in the other word sequences 212 of the selected candidate word set.

At step 316, the method determines if there are more candidate word sets. If there are more candidate word sets, the next candidate word set is selected at step 304. In general, a separate candidate word set will be provided for each input 202 (for example, each phonetic string or each speech signal). Steps 306, 308, 310, 312 and 314 are then repeated for the new candidate word set, producing a margin for each word sequence in other word sequences 212 of the candidate word set.

At step 318, a new value for base feature weight is computed using Newton's method based on an exponential loss function that is defined as:

$$ExpLoss ( λ ) = {\sum }_{i = 1}^{C} {\sum }_{{W}_{i} ∈ CWS}^{ } exp ( - M ( {W}_{i}^{R} , {W}_{i} ) \qquad EQ . 4$$

where the outer summation is taken over all candidate word sets C, the inner summation is taken over all word sequences in the set of other candidate word sequences (CWS) 212 of a candidate word set, “exp” represent an exponential function, and M(Wᵢ^{R},Wᵢ) are the margins as computed at step 312 using equation 3.

Using Newton's method and the exponential loss function of Equation 4, the update equation for the base feature weight value becomes:

$${λ}_{0 , n + 1} = {λ}_{0 , n} - \frac{{\sum }_{i = 1}^{C} {\sum }_{{W}_{i} ∈ CWS}^{ } - {λ}_{0 , n} exp ( - M ( {W}_{i}^{R} , {W}_{i} ) )}{{\sum }_{i = 1}^{C} {\sum }_{{W}_{i} ∈ CWS}^{ } - ( 1 - {λ}_{0 , n}^{2} ) exp ( - M ( {W}_{i}^{R} , {W}_{i} ) )} \qquad EQ . 5$$

where λ_{0,n} is the value of base feature weight λ₀ at iteration n of the method of FIG. 3, λ_{0,n+1} is the value of base feature weight λ₀ at iteration n+1, and M(Wᵢ^{R},Wᵢ) is the margin as computed using equation 3 in step 312.

At step 320, the method determines if more training iterations are needed to set the value for the base feature weight. This can be based on a fixed number of iterations or on convergence of the base feature weight value. If more iterations are to be performed, the process returns to step 304 to select a candidate word sequence and steps 304-318 are repeated for the new value for the base feature weight.

When no more iterations are to be performed at step 320, the last value for λ₀ is stored at step 322 and the process of FIG. 3 ends at step 324. This stored value is then used as the value for the base feature weight during the remaining training of the other feature weights. One reason for doing this is that the log probability of the base feature typically has a different range from other features used to form the score. In addition, this helps to ensure that the contribution of the log likelihood feature is well calibrated with respect to the exponential loss.

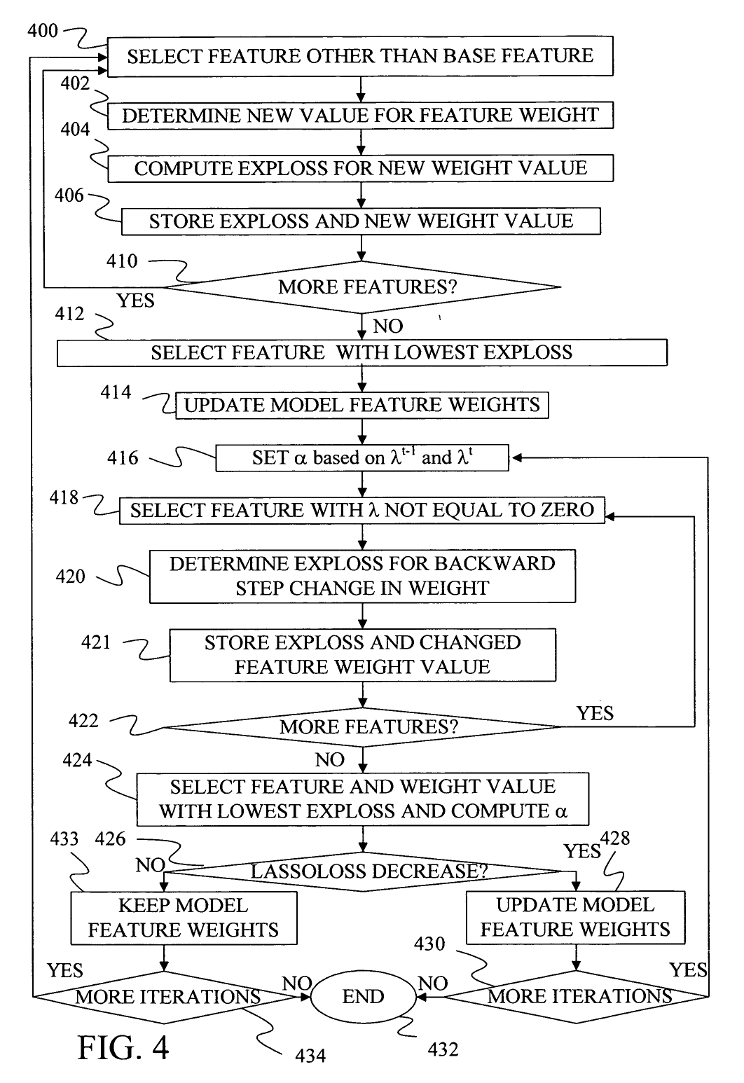

Returning to FIG. 1, at step 109, a limit is set for the amount by which feature weight values may be changed. Under one embodiment, this limit is set to 0.5. At step 110, model trainer 214 begins to alter feature weights to reduce the exponential loss function of EQ. 4. FIG. 4 provides a flow diagram of an iterative method for incrementally changing the weights.

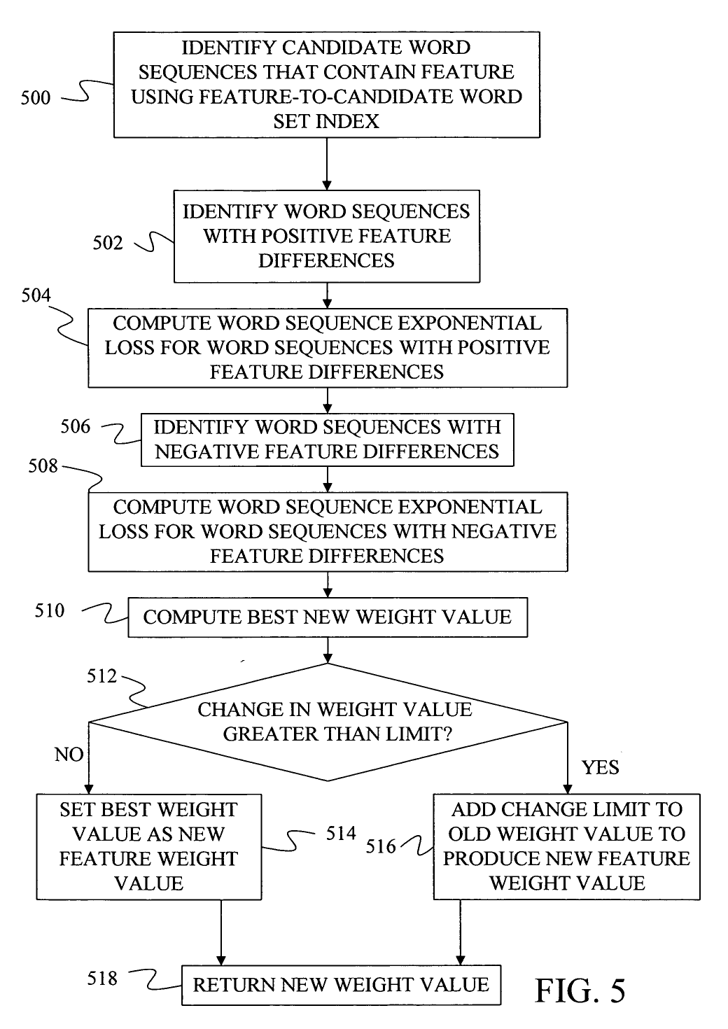

In step 400 of FIG. 4, a feature from features 218 other than the base feature is selected by model trainer 214. At step 402, a next value for a feature weight λ^{t+1} for the selected feature is determined. FIG. 5 provides a flow diagram for computing the next value for the selected feature weight.

In step 500 of FIG. 5, candidate sets that contain the selected feature are identified using feature-to-candidate set index 216.

At step 502, word sequences in the identified candidate sets that have positive feature differences for the selected feature are identified. A positive feature difference is defined as:

f_{d}(W^{R})−f_{d}(Wᵢ)>0 EQ. 6

The word sequences with such positive feature differences are grouped in a set A_{d}⁺ for feature d. In embodiments where feature-to-candidate set index 216 identifies individual word sequences that contain the selected feature, step 502 can be performed by investigating only those word sequences listed in the index for the feature.

At step 504, a word sequence exponential loss, W_{d}⁺, for word sequences with positive feature differences is computed as:

$${W}_{d}^{+} = {\sum }_{{W}_{i} ∈ {A}_{d}^{+}}^{ } exp ( - M ( {W}_{i}^{R} , {W}_{i} ) \qquad EQ . 7$$

At step 506, word sequences in the identified candidate sets that have negative feature differences for the selected feature are identified. A negative feature difference is defined as:

f_{d}(W^{R})−f_{d}(Wᵢ)<0 EQ. 8

The word sequences with such negative feature differences are grouped in a set A_{d}⁻ for feature d. In embodiments where feature-to-candidate set index 216 identifies individual word sequences that contain the selected feature, step 506 can be performed by investigating only those word sequences listed in the index for the feature.

At step 508, a word sequence exponential loss, W_{d}⁻, for word sequences with negative feature differences is computed as:

$${W}_{d}^{-} = {\sum }_{{W}_{i} ∈ {A}_{d}^{-}}^{ } exp ( - M ( {W}_{i}^{R} , {W}_{i} ) \qquad EQ . 9$$

At step 510, a best new value for the feature weight is computed, where the best new value is the value that produces the greatest reduction in the exponential loss of equation 4. Under one embodiment, a gradient search is used which defines the best new value as:

$$Best {λ}_{d} = \frac{1}{2} log \frac{{W}_{d}^{+}}{{W}_{d}^{-}} \qquad EQ . 10$$

Under some embodiments, smoothing parameters may be added to equation 10 to prevent parameter estimates from being undefined when either W_{d}⁺ or W_{d}⁻ are zero.

At step 512, the difference between the absolute value of the best new value for the feature weight and the absolute value for the old value for the feature weight is compared to the change limit set for feature weights at step 109. If the difference is less than the change limit, the best feature weight value is stored as the new feature weight value at step 514. If the difference is greater than the change limit, the change limit is added to the old feature weight to form a step-change value for the feature weight and the step-change value is stored as the new feature weight value. The new feature weight value is then returned at step 518.

Note that in steps 514 and 516, the change in the absolute value of the feature weight is in a positive direction. As such, this change is referred to as a forward step in the feature weight.

By limiting the range of values for the next value of the weight, the growth of the complexity of the parameters is somewhat controlled when adjusting the values of the weights. In addition, the changes in the weights are not limited to step wise changes of a fixed step size. Instead, if a change in the weight that is less than the change limit provides the best weight value at step 510, the present invention uses that change in weight. This optimizes the exponential loss while at the same time limiting the increase in the complexity.

Returning to FIG. 4, after determining a new value for a feature weight, the exponential loss is computed using the best value for the feature weight in equation 4 at step 404. The exponential loss, the feature, and the value of the feature weight are then stored at step 406. Note that the value for the feature weight is stored separately from the current values of the feature weights. In other words, steps 402, 404 and 406 do not update feature weights 220 in language model 219. As such, when steps 402 and 404 are performed for another feature, the new value of the feature weight identified in step 402 for the current feature will not be used. Instead, the value of the feature weight before step 402 was performed for the current feature will be used. As such, the new feature weight value for each feature is determined independently of the new feature weight values for other features.

At step 410, the method determines if there are more features in features 218. If there are more features, the next feature is selected by returning to step 400. Steps 402 and 404 are then performed for the newly selected feature. When there are no more features at step 410, the feature with the lowest exponential loss is selected at step 412. At step 414, feature weights 220 are updated by changing the feature weight value of the feature selected at step 412 to the new feature weight value determined for the feature at step 402. After the update, the values stored in feature weights 220 are the current feature weights λ^{t}, and the values that were previously in feature weights 220 become previous feature weights λ^{t-1}.

At step 416, the control parameter α used to compute a Lasso Loss as in equation 1 above is set. In equation 1, ExpLoss(λ) is the exponential loss calculated in EQ. 4 and T(λ) is an L₁ penalty of the model which is computed as:

T(λ)=Σ_{d=0}^{D}|λ_{d}| EQ. 11

where |λ_{d}| is the absolute value of feature weight λ_{d}. In one particular embodiment, α is set as:

$${α}^{t + 1} = min ( {α}^{t} , ( \frac{ExpLoss ( {λ}^{t - 1} ) - ExpLoss ( {λ}^{t} )}{ɛ} ) ) \qquad EQ . 12$$

where α^{t+1} is the updated value of α, α^{t} is the current value of α, ExpLoss(λ^{t-1}) is the exponential loss of equation 4 before updating the model parameters, ExpLoss(λ^{t}) is the exponential loss after updating the model parameters and ε is the change limit or step size used to limit the change in the weight in step 402.

At step 418, a feature is selected that has a feature weight value that is not equal to zero in feature weights 220. Thus, this is a feature weight that has been incremented in step 414. At step 420, the value of the feature weight for the selected feature is changed by reducing the magnitude of the value by a step value such that the weight becomes:

λₖ^{t+1}=λₖ^{t-sign(λ}ₖ^{t})ε EQ. 13

where k is the selected feature, λₖ^{t} is the value of the weight for the selected feature before changing the weight, sign(λₖ^{t}) is the sign of the feature weight, and ε is the stepwise change in the weight, which under one embodiment is the same as the maximum allowable change in the weight in step 402. Since this change in the weight results in a reduction of the absolute value of the weight, it is considered a backward step change in the weight value.

Using this possible backward step change in the weight value together with the current feature weight values of the other features, the exponential loss is computed in step 420 using EQ. 4 above. At step 421, the exponential loss and the associated changed feature weight value are stored. Note that the changed feature weight value is stored separately from feature weights 220 and as such, feature weights 220 are not updated at step 421. As a result, when the exponential loss is calculated for another feature at step 420, the changed feature weight value for the current feature will not be used.

At step 422, trainer 214 determines if there are more features that have a feature weight that is not equal to zero. If there are more features, the process returns to step 418 to select the next feature. Step 420 is then performed for the new feature. When all of the features that have a feature weight that is not equal to zero have been processed, the method continues at step 424 where the feature and corresponding change in feature weight value that produces the lowest exponential loss in step 420 is selected and are used to compute a new possible value for α using equation 12 above. In particular, in equation 12 λ^{t} is the set of feature weight values with the backward step change in the selected feature weight value and λ^{t-1} is the set of feature weights stored in feature weights 220.

At step 426, the method determines if the feature weight value after the backward step results in a decrease in the Lasso loss of Equations 1 and 11. This is determined as:

Diff=LassoLoss(λ^{t},α^{t})−LassoLoss(λ^{t+1},α^{t+1}) EQ. 14

where λ^{t} represents the set of feature weight values in feature weights 220 before the backward step, α^{t} is the value of a before the backward step, λ^{t+1} is the set of feature weight values after the backward step for the selected feature, and α^{t+1} is the value of α after the backward step.

If the difference in equation 14 is positive, there is a decrease in the Lasso loss with the backward step. If there is Lasso loss decreases with the backward step at step 426, the feature weights 220 are updated at step 428 to reflect the backward step in the selected feature. After the feature weights have been updated, the method determines if more iterations of feature weight value adjustment are to be preformed at step 430. If more iterations are to be performed, the process returns to step 416 to calculate a new value for α using EQ. 12 above and the updated feature weights from step 428. Steps 418 through 426 are then performed using the new feature weights 220 and the new value of α.

If the Lasso loss does not decease at step 426, the backward step to the selected feature is not used to update the model feature weights 220. As such, the feature weight value of the selected feature in feature weights 220 is maintained at the value it had before the backward step as shown by step 433. At step 434, the process determines if there are more iterations of feature weight value adjustment to be performed. If more iterations are to be performed, the process returns to step 400 to select a feature and steps 402, 404, 406 and 410 are performed to identify a forward step for a feature weight.

When no more iterations are to be performed either at step 430 or step 434, the process of modifying the feature weights ends at step 432. The resulting feature weights 220 are the trained feature weights that can then be used in a language model for either speech recognition or phonetic-to-character conversion.

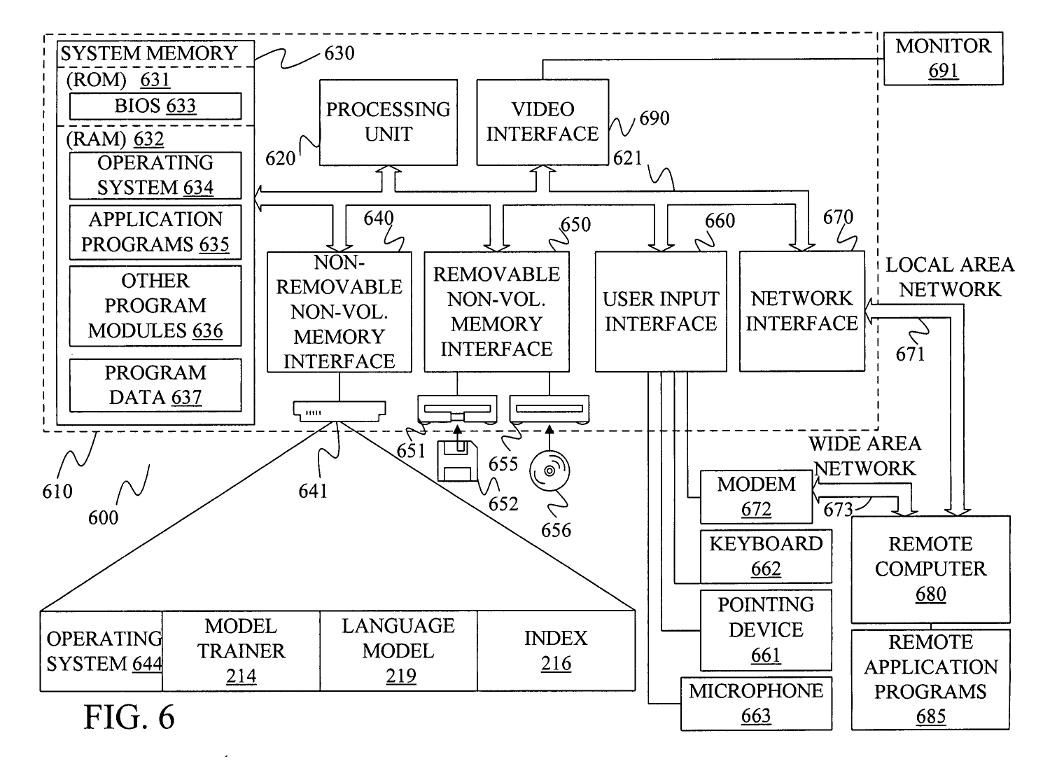

FIG. 6 illustrates an example of a suitable computing system environment 600 on which embodiments may be implemented. The computing system environment 600 is only one example of a suitable computing environment and is not intended to suggest any limitation as to the scope of use or functionality of the claimed subject matter. Neither should the computing environment 600 be interpreted as having any dependency or requirement relating to any one or combination of components illustrated in the exemplary operating environment 600.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 6, an exemplary system for implementing some embodiments includes a general-purpose computing device in the form of a computer 610. Components of computer 610 may include, but are not limited to, a processing unit 620, a system memory 630, and a system bus 621 that couples various system components including the system memory to the processing unit 620.

Computer 610 typically includes a variety of computer readable media. Computer readable media can be any available media that can be accessed by computer 610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 630 includes computer storage media in the form of volatile and/or nonvolatile memory such as read only memory (ROM) 631 and random access memory (RAM) 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, model trainer 214, language model 219 and index 216.

A user may enter commands and information into the computer 610 through input devices such as a keyboard 662, a microphone 663, and a pointing device 661, such as a mouse, trackball or touch pad. Other input devices (not shown) may include a joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 621 via an interface, such as a video interface 690.

The computer 610 is operated in a networked environment using logical connections to one or more remote computers, such as a remote computer 680. The remote computer 680 may be a personal computer, a hand-held device, a server, a router, a network PC, a peer device or other common network node, and typically includes many or all of the elements described above relative to the computer 610. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through a network interface or adapter 670. When used in a WAN networking environment, the computer 610 typically includes a modem 672 or other means for establishing communications over the WAN 673, such as the Internet. The modem 672, which may be internal or external, may be connected to the system bus 621 via the user input interface 660, or other appropriate mechanism. In a networked environment, program modules depicted relative to the computer 610, or portions thereof, may be stored in the remote memory storage device. By way of example, and not limitation, FIG. 6 illustrates remote application programs 685 as residing on remote computer 680. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
setting a limit for the amount by which feature weights can be changed during a single iteration of training of feature weights in a language model;
selecting a feature weight from the set of feature weights;
computing a best value for the selected feature weight, wherein the best value comprises a value that results in the greatest change in a function, and wherein the best value differs from a previous value for the selected feature weight by a change amount;
determining if the absolute value of the change amount is less than the limit;
selecting the best value for the selected feature weight instead of a step-change value for the selected feature weight as a new value for the selected feature weight if the absolute value of the change amount is less than the limit, wherein the step-change value is formed by increasing the absolute value of the previous value of the feature weight by the limit; and
storing the new value for the feature weight as part of a current set of feature weights for the language model.

2. The method of claim 1 wherein computing the best value for the selected feature weight comprises:
identifying word sequences that contain the selected feature;
computing at least two word sequence exponential losses based on the identified word sequences; and
using the word sequence exponential losses to compute the best value.

3. The method of claim 2 wherein identifying word sequences comprises applying the feature associated with the selected feature weight to an index that has an entry for each feature, wherein each entry identifies candidate word sets in which the feature appears, wherein the candidate word sets comprise a plurality of word sequences.

4. The method of claim 2 wherein identifying word sequences comprises applying the feature associated with the selected feature weight to an index that has an entry for each feature, wherein each entry identifies word sequences in which the feature appears.

5. The method of claim 1 further comprising:
forming a first set of feature weights by changing a value for a first feature weight in the current set of feature weights, the first feature weight being changed by the limit amount such that the absolute value of the first feature weight decreases;
determining a first value for a loss function based on the first set of feature weights;
forming a second set of feature weights by changing a second feature weight in the current set of feature weights, the second feature weight being changed by the limit amount such that the absolute value of the second feature weight decreases;
determining a second value for the loss function based on the second set of feature weights; and
selecting one of the sets of feature weights based on the values for the loss function.

6. The method of claim 5 further comprising:
determining a current value for a lasso loss function based on the current set of feature weights, wherein the lasso loss function is a combination of the loss function and a penalty based on the size of the feature weights;
determining an updated value for the lasso loss function based on the selected set of feature weights;
if the current value of the lasso loss function is greater than the updated lasso loss function, setting the selected set of feature weights as the current set of feature weights.

7. The method of claim 6 wherein if the current value of the lasso loss function is less than the updated lasso loss function, keeping the current set of feature weights as the current set of feature weights.

8. The method of claim 1 further comprising initializing a value for a base feature weight to minimize a loss function with the values for all other feature weights set to zero.

9. A computer-readable medium having computer-executable instructions for performing steps comprising:
selecting a feature of a language model;
identifying word sequences that contain the feature using an index that comprises a separate entry for each of a collection of features in the language model, each entry identifying word sequences that contain the feature;
using the identified word sequences to compute a best value for a feature weight of the selected feature;
selecting one of the best value and a step-change value for the feature weight as a new value for the feature weight; and
storing the new value for the feature weight in a current set of feature weights for the language model.

10. The computer-readable medium of claim 9 wherein at least one entry identifies a candidate word set, wherein the candidate word set comprises at least one word sequence that contains the selected feature.

11. The computer-readable medium of claim 10 wherein at least one entry comprises a list of individual word sequences that each contain the selected feature.

12. The computer-readable medium of claim 1 wherein selecting one of the best value and the step-change value comprises selecting the value with the smallest absolute value.

13. The computer-readable medium of claim 9 wherein before storing the updated value:
computing an exponential loss based on the new value for the feature weight;
comparing the exponential loss to an exponential loss computed based on a current value for the weight and a possible new value for a feature weight associated with another feature; and
determining whether to store the new value based on the comparison.

14. The computer-readable medium of claim 9 wherein selecting a feature further comprises excluding a base feature from being selected, the feature having a base feature weight that is set when feature weights for all other features are equal to zero.

15. The computer-readable medium of claim 9 further comprising determining whether to reduce the absolute value of a feature weight based on a lasso loss function that includes a penalty factor that is based on the absolute value of feature weights.

16. A method comprising:
applying a feature for a language model to an index comprising a separate entry for each feature of the language model to identify a plurality of word sequences that contain the feature;
using features contained in at least one of the identified word sequences to compute a word sequence exponential loss function;
using the word sequence exponential loss function to determine a value for a feature weight for the feature; and
storing the value for the feature weight as part of a language model.

17. The method of claim 16 wherein using the word sequence exponential loss function to determine a value comprises using the word sequence exponential loss function to determine a value that results in the largest possible change in an exponential loss function.

18. The method of claim 17 further comprising determining if the determined value for the feature weight has an absolute value that is greater than an absolute value of a step-change value for the feature weight and storing the step-change value instead of the determined value if the absolute value of the determined value is greater than the absolute value of the step-change value.

19. The method of claim 16 wherein each entry in the index provides a list of candidate word sets, each candidate word set comprising a plurality of word sequences wherein at least one of the word sequences contains the feature for the entry.

20. The method of claim 16 further comprising changing a feature weight to reduce its absolute value by the maximum value, determining that the change in the feature weight reduces a lasso loss function that is based in part on the absolute values of feature weights, and storing the change in the feature weight as part of the language model.
